(19) United States
(12) Patent Application Publication
(10) Pub. No.: US 2008/0050630 A1
(43) Pub. Date: Feb. 28, 2008

(54) Membrane-Electrode Assemblies for Fuel Cell, Their Manufacture and Use and Fuel Cells Incorporating Them

(75) Inventors: Paolo Bert, Como (IT); Claudio Bianchini, Firenze (IT); Stefano Catanorchi, Piombino (IT); Giuliano Giambastiani, Barberino Di Mugello (IT); Alessandro Tampucci, Collesalvetti (IT); Francesco Vizza, Firenze (IT)

Correspondence Address: KNOBBE MARTENS OLSON & BEAR LLP, 2040 MAIN STREET, FOURTEENTH FLOOR, IRVINE, CA, 92614, US

(73) Assignee: ACTA S.P.A., Crespina (IT)

(21) Appl. No.: 11/813,756

(22) PCT Filed: Mar. 29, 2005
(86) PCT No.: PCT/EP05/51423

§ 371 Date: Jul. 11, 2007

(30) Foreign Application Priority Data
Jan. 11, 2005 (IT) FI2005A000002

(51) Int. Cl. H01M 8/10

(52) U.S. Cl. 429/27; 429/42

(57) ABSTRACT

Fuel cell incorporating membrane-electrode assembly, methods for preparing the latter and their use in fuel cells are described.

### FIELD OF THE INVENTION

The present invention relates to the field of fuel cell. More particularly, it relates to a fuel cell incorporating a membrane-electrode assembly (MEA) where the electrocatalysts are embedded in the anion conducting membrane with which they form a unique, inseparable body.

### STATE OF THE ART

Fuel cells are electrochemical devices that convert the chemical energy of a reaction directly into electrical power. In such cells, a fuel (generally hydrogen, alcohols, carbohydrates or saturated hydrocarbons) and an oxidant (generally oxygen from air) are fed in a continuous supply to the electrodes. Theoretically, a fuel cell can produce electrical energy for as long as the fuel and oxidant are supplied to the electrodes. In reality, degradation or malfunction of the components limits the practical operating life of fuels cells.

Nowadays, a variety of fuel cells in different stages of development are known. Considering, in particular, fuel cells in which the membrane-electrode assembly (hereinafter referred to as MEA) the followings can be mentioned as examples: Polymer Electrolyte Fuel Cell (PEFCs) fuelled with H₂, Direct Alcohol Fuel Cell (DAFC) fuelled with alcohols and polyalcohols (methanol, ethanol, ethylene glycol, to mention but a few), and, more generally, Direct Oxidation Fuel Cells (DOFC) fuelled with any hydrogen-containing liquid, solid or gaseous fuel (sugars, carbohydrates, aldehydes, saturated hydrocarbons, carboxylic acids, alkali metal borohydrides, hydrazine).

Characterizing and essential components of any fuel cell of the types mentioned above are the electrolyte, formed by an ion-exchange polymeric membrane, and the electrodes. These contain metals or metal particles, generally dispersed on conductive, porous support materials, that have the role of accelerating the rates of the electrode reactions. Besides allowing for ionic transport, the membrane has the role of separating the reagents (for example, H₂ and O₂ in PEMFC and alcohol and O₂ in DAFC) as well as performing as electronic insulator. The ion-exchange polymer electrolyte membrane may comprise either a proton (H⁺) conducting polymer or an anion, generally OH⁻, conducting polymer.

The ensemble of electrodes and membrane constitutes the so-called membrane-electrode assembly. The MEAs of the art are generally realized by a ion-exchange polymer electrolyte membrane on both sides of which are mechanically pressed the electrodes (on one side the cathode, positive electrode, and the anode, negative electrode onto the other side). The electrodes are generally formed by conductive and gas-permeable materials (for example graphitic materials) on which are deposited metal complexes, metals or metal particles, even nanosized. Catalysts usually employed for oxidizing the fuel (for example H₂ in the PEFC and methanol or ethanol in DAFC) are platinum alone, platinum in conjunction with other metals (ruthenium, ruthenium-molybdenum, tin, for instance) or nickel in conjunction with iron and/or cobalt.

It is known by those who are skilled in the art that the electrodes and the ion-exchange membrane must be mutually contiguous and that optimizing the mutual conjunction of these components optimizes the performance of the fuel cell. Indeed, a continuous contact between the electrodes and the membrane must be maintained in order to not interrupt the ionic communication between anode and cathode. Due to many factors, for example the degradation of the membrane and of the electrode conductive support, the communication between the anode and cathode may be interrupted and the fuel cell ceases to work. In order to reduce or even overcome this drawback, the electrocatalysts should be directly deposited on both major surfaces of the ion-exchange membranes. However, in the case of proton-exchange membranes for use in a fuel cell, the cathode side of the membrane cannot be directly metallized by the metal element that catalyzes the oxygen reduction because the water that forms during the cell functioning would hinder the adsorption and diffusion of oxygen. For other purposes, such as the preparation of metal film electrodes with improved sensitivity for ammonia detection (Taiwan patent n^{o}. 461925), the metallization of both sides of Nafion® membranes by catalytically active elements is a viable procedure. Likewise, U.S. Pat. No. 5,906,716 describes cation-exchange membranes where, on at least one side of the membrane, there are applied finely divided metals that catalyze the formation of water from H₂ and O₂.

Increasing research and development activities are being focused on anion-exchange membrane fuel cells. These fuel cells have MEAs containing an anion-exchange membrane which allows hydroxide ion conduction from the cathode to the anode. The advantages of using an anion-exchange membrane over a cation-exchange membrane are manifold, especially for DAFCs (for example, the reversible potentials Eᵣₑᵥ⁰ of ethanol and methanol are −0.743 and −0.770 V in alkaline medium and +0.084 and +0.046 V in acidic medium, respectively). Indeed, the favorable oxidation potentials allow for the use of non-noble metal catalysts in PEFC, DOFC and DAFC (patent application “Platinum-free electrocatalysts materials” PCT/EP 2003/006592). A further advantage of using an alkaline anion-exchange membrane over using a proton-exchange membrane is provided by the reduced alcohol crossover as the electro-osmotic drag of the hydrated hydroxide ion opposes alcohol transport. Finally, both major surfaces of anion-exchange membranes can be coated with catalytically active metal species since water is produced at the anode and not at the cathode. Equations 1 and 2 that account for the electrochemical reactions occurring at the anode of a direct ethanol fuel cell equipped with either a cation-exchange membrane (1) or an anion-exchange membrane (2):
C₂H₅OH+3H₂O→2CO₂+12H⁺+12e⁻ (1)
C₂H₅OH+12OH⁻→2CO₂+9H₂O+12e⁻ (2)

Therefore, it would be highly desirable to develop and manufacture MEAs where the anode and cathode are integral part of the anion-exchange membrane with no need of distinct components held together mechanically. Such a goal implies coating one major surface of the membrane with the metal catalyst for fuel oxidation, and the other with metal catalyst for oxygen reduction, with both the catalysts adhering tightly, stably and permanently to the surfaces of the membrane. Obviously, the catalysts, commonly in the form of nanostructured metal particles, must reside in a conductive environment to allow electrons to flow through the electrode and be transferred outside via the backing current collector.

U.S. Pat. No. 5,853,798 reports a method for the preparation of an electrode on solid polymer anion-exchange membrane to increase rates of reaction at a reaction surface of the membrane, with particular reference to electrodialytic-type electrochemical cells used for salt splitting. The described process includes the steps of soaking a polymer anion-exchange membrane in a solution containing an anionic entity wherein a desired metal catalyst is contained so that anions containing the metal catalyst exchange into the membrane by electrostatic attraction. Thereafter, the membrane is exposed to a reducing agent so that the metal catalyst is reduced to a catalytically active metallic form.

U.S. Pat. No. 3,351,487 describes a method for plating the surfaces and the inner hollows of ion-exchange hollow fiber membranes with an electrically conductive metallic film made of a single metal element. The described process includes the steps of contacting one side of the membrane with a solution of a compound of the metal to be plated and contacting the opposite side of the membrane with a solution of a reagent capable of reducing the metal compound through the diffusion into the membrane.

### DESCRIPTIONS OF THE DRAWINGS

FIG. 1 represents a cross-section schematic view of a simplified fuel cell operating with the MEA of the invention.

FIG. 2 (a-b) shows a schematic view of the device used to coat the major surfaces of an anion-exchange membrane with a metal (a); exploded perspective view (b).

FIG. 3 (a-b) shows a schematic view of the device used to support on the metal-coated major surfaces of an anion-exchange membrane with electrocatalytic materials (a); exploded perspective view (b).

FIG. 4 shows a polarization curve of a PEFC fuelled with pure H₂ (1 bar) and oxygen (1 bar) at 60° C., containing a MEA of the invention prepared as described in EXAMPLE 2.

FIG. 5 shows a polarization curve of a DMFC fuelled with an aqueous solution of 10 wt. % methanol at 50° C. (1 bar O₂) containing a MEA of the invention prepared as described in EXAMPLE 7.

FIG. 6 shows a polarization curve of a self-breathing DEFC fuelled with an aqueous solution of 10 wt. % ethanol at 30° C., containing a MEA of the invention prepared as described in EXAMPLE 3.

FIG. 7 shows the variation of the current intensity with time at a constant potential of 0.5 V for a monoplanar cell bearing the MEA of the invention described in EXAMPLE 3.

FIG. 8 shows a polarization curve of a self-breathing DAFC fuelled with an aqueous solution of 10 wt. % ethylene glycol at 25° C., containing a MEA of the invention prepared as described in EXAMPLE 5.

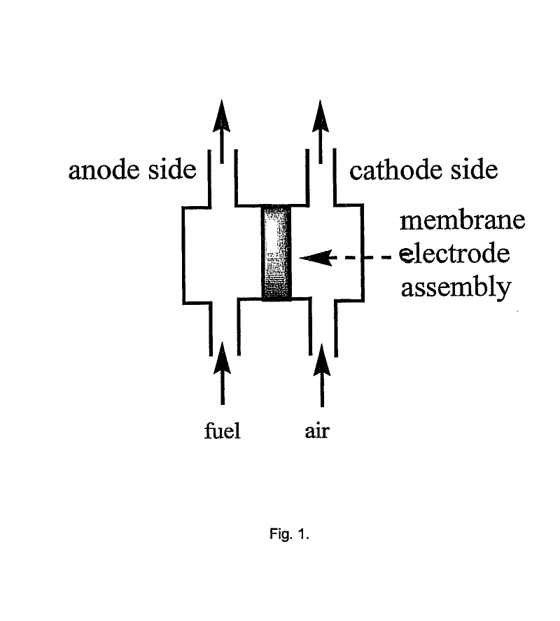

### DETAILED DESCRIPTION OF THE INVENTION

The present invention describes MEAs comprising anion-exchange membranes wherein the anodic and cathodic electrocatalysts are embedded in the membrane forming a unique, inseparable body, and also provides a method to make the MEAs of the invention which are suitable for use in electrochemical devices, including PEFC, DAFC, DOFC, electrolyzers and like.

The Applicant has found that anion-exchange membranes can be transformed, in a simple and practical manner, into above-mentioned MEAs by coating the major surfaces of the membrane with a porous and electrically conductive metal layer that is then used as support material for catalytically active metals or metal compounds. The MEAs of the present invention may include any alkaline anion-exchange polymer membrane, for example membranes based on polyolefins, fluorinated ethylene/polypropylene copolymers, polysulfones, ethylene oxide-polyepichlorohydrin copolymers, prepared by either grafting with radiation of suitable energy, chloromethylation or sulfochloromethylation. Among commercial anion-exchange membranes that can be used to make the MEAs of the present invention can be cited “Tokuyama Soda AMH membrane” (Tokuyama Soda Co. Ltd., Japan), Morgane ADP and Morgane AD (Solvay S. A.), Selemion AMW (Asahi Glass), RAI R4030 membrane (Pall RAI, Inc. N.Y., USA), to say but a few.

According to the invention, the porous and electrically conductive metal layer, acting, as mentioned above, as a support for catalysts, can be deposited evenly on both the major surfaces of the anion-exchange membrane or can even penetrate the membrane itself, obviously without reaching the contact with the metal layer deposited on the opposite surface (for this will cause short circuit in the MEAs).

Preferred metal compounds to coat the major surfaces of anion-exchange membranes with a porous metal layer are compounds or salts of a metal selected from the class consisting of Ag, Au, Pt, Ni, Co, Cu, Pd, Sn, Ru, more preferably nickel and cobalt citrate, potassium tetrachloroplatinate, silver and cobalt nitrate, potassium tetrachloroaurate.

Preferred reducing agents have a reducing potential greater than the reducing potential of the metal compound from which the metal is to be reduced and are selected in the class consisting of hydrazine, hydrazine hydrate, alkaline metal borohydrides, alkaline metal hydrosulfite, alkaline metal sulphites, to mention but a few.

The catalytically active metals or metal compounds used according the invention are those known to be able to act as anode catalysts or, respectively, cathode catalysts for fuel-cell electrodes. The anode catalysts are preferably chosen in the class consisting of Pt, Ni, Co, Fe, Ru, Sn, Pd and mixture thereof, while cathode catalysts are preferably chosen in the class consisting of cobalt, nickel and rhodium phthalocyanine or tetraphenylporphyrin, Co salen, Ni salen (salen=N,N′-bis(salicylidene)ethylendiamine), silver nitrate, just to mention a few.

The MEAs according to the invention can be manufactured, for example, by a procedure that involves the following steps:

a) treatment of an anion-exchange membrane, of any shape and size, with a concentrated aqueous solution of a strong Brønsted base for some hours, followed by rinsing with deionized water;

b) adsorbing an anionic entity, wherein a desired metal for metallization, preferably nickel or cobalt, is contained, on one major side of the membrane by ion-exchange reaction between counter-ions of the membrane and the metal-containing anionic entity;

c) treatment of the surface of the membrane on the opposite side than that treated on step (b) with an aqueous solution of a metal salt capable of forming a layer of an insoluble metal hydroxide/oxide over the membrane surface by reaction with the OH⁻ groups contained in the membrane, preferably a silver salt if the metal on the other side is either nickel or cobalt, until all the surface is coated by a precipitate of metal oxide;

d) reduction of the adsorbed metal anions on one side of the membrane and of the supported metal oxide on the opposite side of the membrane to a metallic form by means of an aqueous solution of a reducing agent of the state of the art;

e) adsorption of a catalytic metal precursor or a mixture of catalytic metal precursors, dispersed in a solvent, over a porous metallic layer of the metal-coated membrane that will act as a cathode in a fuel cell. Above-mentioned catalytic metal precursors may be known in the state of the art as capable of generating active cathode catalysts in fuel cells (for example nickel or cobalt complexes with polyazamacrocycles);

f) adsorption of a catalytic metal precursor or a mixture of catalytic metal precursors, dispersed in a solvent, on the opposite porous metal layer of the metal-coated membrane described in step (e). Above-mentioned catalytic metal precursors may be known in the state of the art as capable of generating, upon reduction, active anode catalysts in fuel cells (for example Pt, Ni, Co, Fe, Ru, Sn, Pd compounds and mixture thereof);

g) reducing above-mentioned metal precursors adsorbed on the surface of the metal-coated anode-side membrane to catalytically active metal particles with an aqueous solution of a reagent capable of reducing to a metallic form the metal ion contained in above-mentioned metal precursors, for example NaBH₄ in aqueous solution.

Step (d), involving treatment of the major surface of the membrane, whereon the metal anions are adsorbed, with an aqueous solution of a reducing agent may precede step (b) and (c) that, in turn, can occur in the inverse order, i.e. step (c) can precede (b).

The use of a metal anionic entity in step (b) (or in step (c) if the mutual order between them is inverted) allows the above-mentioned metal anions to exchange with the mobile and replaceable hydroxyl ions (OH⁻) electrostatically associated with the fixed cationic components of the membrane, generally quaternary amines cations. The metal anionic entity can therefore permeate the membrane and the extent of permeation will depend on both the structure of the parent membrane and the contact time between the aqueous solution of the metal anionic entity and the surface of the membrane. For the purpose of the present invention, the above-mentioned contact time is preferably shorter than 2 hours at room temperature for any parent membrane. A longer contact time will obviously increase the permeation depth, making the metallized membrane useless for the fabrication of the MEAs of the invention. The process of above-mentioned coating may be repeated several times until a uniform coating of both major surfaces of the membrane is obtained.

Preferred reducing agents have a reducing potential greater than the reducing potential of the metal compound from which the metal is to be reduced and is selected from the class consisting of hydrazine, hydrazine hydrate, alkali metal borohydrides, alkaline metal hydrosulfite, alkaline metal sulphites, to mention but a few.

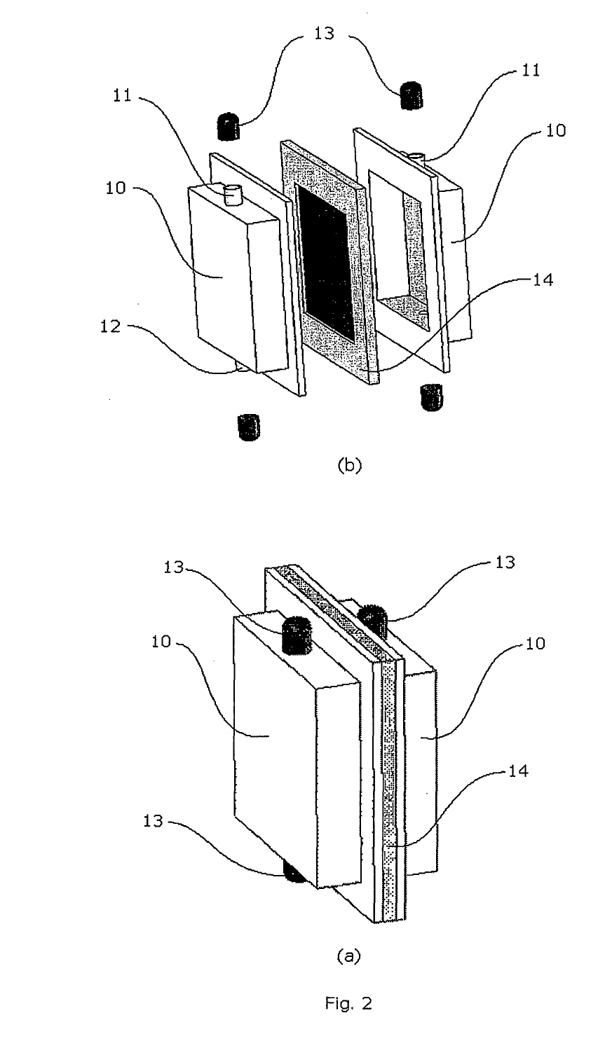

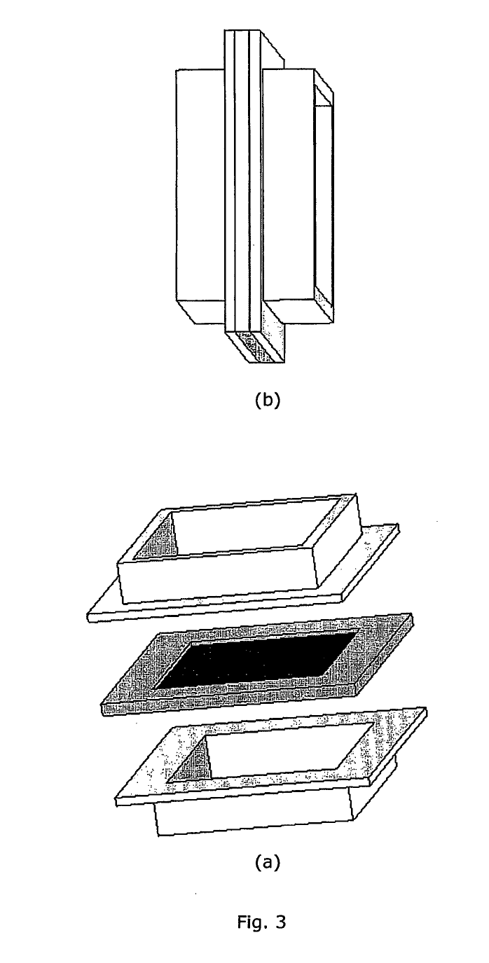

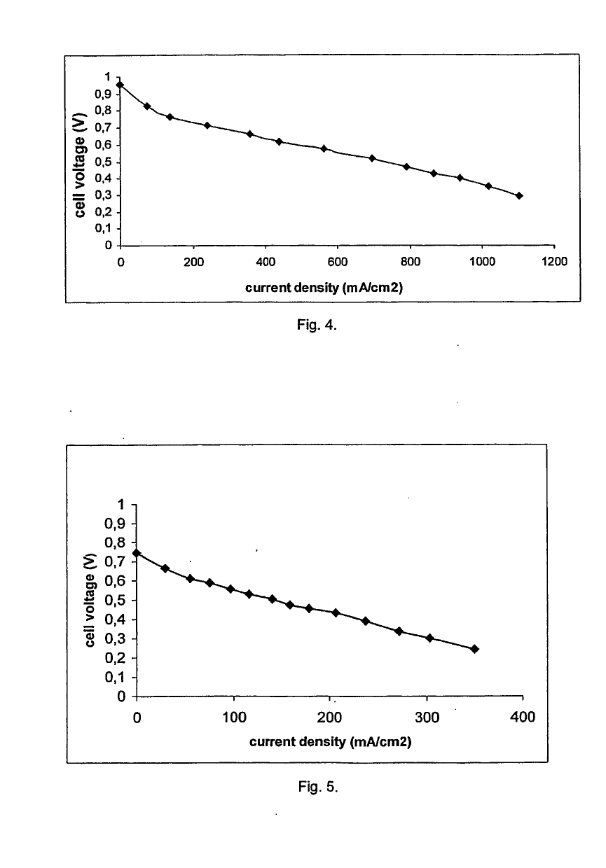

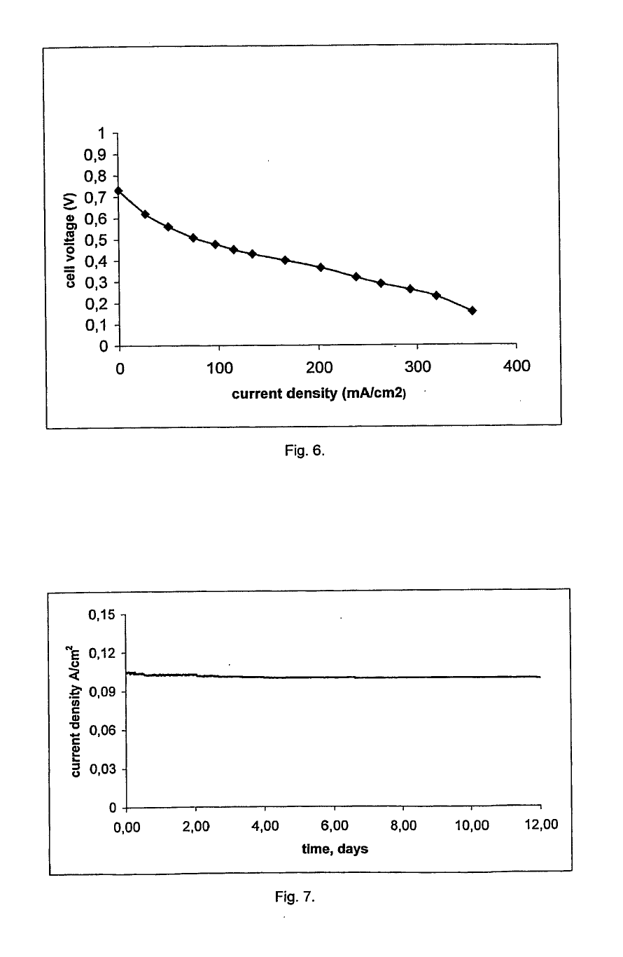

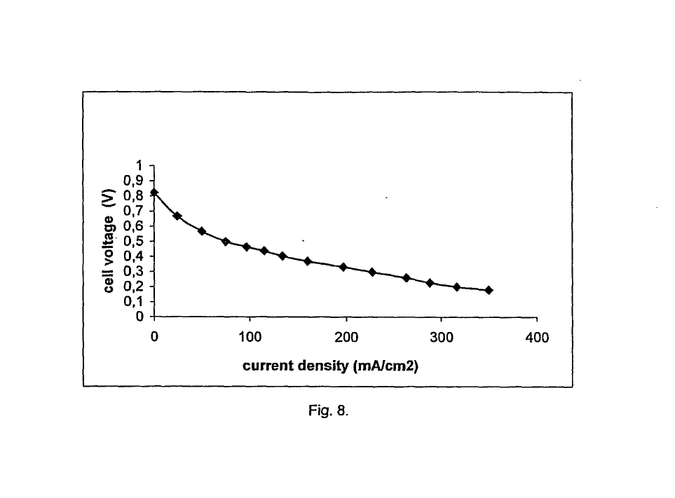

According to a particular embodiment of the invention, the above-described process can be carried out using a device as shown in FIGS. 2 and 3. More particularly, the device shown in FIG. 2(a-b) can be used to coat the major surfaces of an anion-exchange membrane with a layer of a porous and conductive metal (steps a-d).

As shown in FIG. 2, the device is formed essentially by two small basins (10), each provided with inlet and outlet opening (respectively 11 and 12) closed with the respective plug (13), able to fit together the respective edge (14), and formed by a gasket (15) to be interposed between the two small basins and acting also as supporting frame for the membrane to be treated.

A single sheet of above-mentioned membrane is positioned by a gasket which provides a seal between the membrane sheet and the joined sections that are held firmly in position by a bolt. Each compartment separated by the membrane has an inlet to introduce the reactant solutions and rinse the membrane surface, generally with deionized water, and an outlet for the removal of the exhausted reagent solutions and rinsing liquids.

For other specific purposes than the fabrication of a MEA, only one major side of the membrane is coated using the procedure detailed above, leaving the other side uncoated.

The device shown in FIG. 3 (a-b), essentially analogue to the previous (different just for the small basins (10) lacking in the bottom and in the inlet and outlet openings) can be instead used to deposit the electro-catalytic materials on the previously metallized surfaces of the membrane (step e-g). In this device, the anion-exchange membrane coated on both the major surfaces with a porous and conductive metal layer, is positioned by a gasket which provides a seal between the membrane sheet and the joined sections of the device which are held firmly in position by a bolt, thus forming two compartments. Each compartment consists of a simple tank, the bottom of which is constituted by a major side of the above-mentioned metal-coated membrane. A solution of a catalytic metal precursor selected to generate the anode catalyst is poured into the tank at room temperature so that of the whole bottom surface is covered by above-mentioned solution. After the time required to adsorb the catalytic metal precursor onto the porous metal layer, the remaining solution is removed and the tank is rinsed with deionized water. Then, an aqueous solution of a reagent capable of reducing the adsorbed metal ion of the selected catalytic metal precursor, NaBH₄ for instance, is poured into the tank so that the whole bottom surface is covered by the above-mentioned solution of a reducing agent. After the desired time at room temperature, all the liquid phase covering the bottom of the tank is removed and the bottom surface is rinsed with deionized water.

The procedure detailed above is repeated on the opposite side of the membrane, except for depositing a solution of a selected metal precursor capable of generating a cathode catalyst for a fuel cell, with no need of a reducing agent.

Preferred catalytic metal precursors to anode catalysts are iron, cobalt and nickel acetates and mixtures thereof coordinated to synthetic resins such as those described in the patent application PCT/EP 2003/006592, hexachloroplatinic acid, tetrachloroauric acid, palladium bis-acetate, palladium dichloride, iridium trichloride, rhodium trichloride, tin tetrachloride, ruthenium trichloride, just to say mention a few.

Preferred catalytic metal precursors to cathode catalysts are cobalt, nickel and rhodium phthalocyanine or tetraphenylporphyrin, Co salen, Ni salen (salen=N,N′-bis(salicylidene)ethylendiammine), silver nitrate, just to mention a few.

Preferred reducing agents have a reducing potential greater than the reducing potential of the metal compound from which the metal is to be reduced and is selected from the class consisting of hydrazine, hydrazine hydrate, alkali metal borohydrides, alkaline metal hydrosulfite, alkaline metal sulphites, to mention but a few.

The MEA of the invention has demonstrated very satisfactory performance in fuel cells operating at low temperatures, in particular in the temperature range from 20° C. to 90° C., and more particularly in PEFC fuelled with H₂, DAFC fuelled with alcohols and polyalcohols (methanol, ethanol, ethylene glycol), and Direct Oxidation Fuel Cells (DOFC) fuelled with glucose, aldehydes, saturated hydrocarbons, carboxylic acids, alkali metal borohydrides, hydrazine.

Standard cell PEFC and DAFC hardware as well as the test cell for measuring membrane conductivity have been purchased from Fuel Cell Technologies (Albuquerque, N. Mex., USA). Electrochemical characterization of the MEAs and fuel cells has been carried out with a Princeton PARSTAT 2273 potentiostat/galvanostat.

The cell resistance of above-mentioned fuel cells depends on the parent anion-exchange membrane used to make the MEA of the invention and is appreciably affected neither by the porous metal coating nor by the catalyst deposition procedures. Likewise, the alcohol crossover in the case of DAFC has been found to depend on the parent anion-exchange membrane whose permeation to alcohols is apparently unaffected by the metal-coating procedure.

In general, the choice of the anode electrocatalyst depends on the fuel. Iron-cobalt-nickel catalysts are preferable for electro-oxidation of methanol and ethanol, and cobalt-nickel catalysts are preferable for electro-oxidation of ethylene glycol and polyalcohols, including sugars.

The MEAs of the invention show excellent stability with time and temperature (FIG. 7) on condition that the latter is maintained below 90° C.

The present invention is further described by the following examples, which, however, are provided for purely illustrative purposes and do not limit the overall scope of the invention itself.

### EXAMPLE 1

1) A Morgane AD (Solvay S. A.) anion-exchange membrane cut to a size of 4 cm by 4 cm was positioned and sealed in the device shown in FIG. 2 as described above wherein the dimensions of the two external compartments were 3 cm×3 cm×0.5 cm for a total volume of 4.5 mL. Both sides of the membrane sheet, each exposed surface measuring 9 cm², were exposed to 1 molar solution (hereafter “M”) potassium hydroxide (KOH) to exchange the membrane to a hydroxide ion form. After 24 hours, the two compartments were drained of the KOH solutions through outlets 3 and 4 of FIG. 2. Both sides of the membrane were then rinsed with deionized water.
2) Through inlet 1 of FIG. 2 was introduced in the corresponding compartment 4.5 mL of a nickel(II) ion solution in water consisting of either 92.7 g nickel hydroxide and 192.13 g of citric acid per liter of solution or 290 g nickel citrate hydrate (SHOWA Chemicals) per liter of solution.
3) Through inlet 2 of FIG. 2 was introduced in the corresponding compartment 4.5 mL of a silver nitrate solution in water consisting of 170 g silver nitrate per liter.
4) After 1.5 hours, outlets 3 and 4 of FIG. 2 were opened and the liquids contained in the two compartments were allowed to drain. Both compartments of the device of FIG. 2 were then rinsed three times with deionized water, and the outlets 3 and 4 were re-sealed.
5) Each compartment was then filled with 4.5 mL of a water solution of NaBH₄ consisting of 152 g NaBH₄ dissolved per liter. After 3 hours, the liquids were allowed to drain through outlets 3 and 4. The compartments were rinsed with deionized water.

### EXAMPLE 2

1) A metal-coated membrane prepared as described in EXAMPLE 1 was removed from the device shown in FIG. 2 and positioned in the device shown in FIG. 3.
2) 5 mL of solution of cobal phthalocyanine (STREM) in dimethylformamide (hereinafter “DMF”)/(tetrahydrofuran (hereinafter “THF”) (1:1, v:v), obtained by dissolving 5 g of cobalt phthalocyanine per liter, was deposited on the membrane surface coated with silver (9 cm²). After 2 hours at room temperature, the membrane surface was rinsed with deionized water.
3) The device shown in FIG. 3 was turned upside down, leaving exposed for manipulation the side of the membrane coated with nickel. A 3 mL portion of a water solution of hexachloroplatinic, H₂PtCl₆, obtained by dissolving 1 g H₂PtCl₆ per 0.1 liter, was poured in the tank having its bottom constituted by the membrane surface coated with nickel. After 2 hours, all the liquid covering the membrane surface was removed from the tank, which was rinsed with deionized water. After the last rinsing, the above-mentioned membrane surface was covered by a 5 ml portion of the aqueous NaBH₄ solution described at point 5 and left standing for 1 hour. Afterwards, all the liquid covering the membrane surface was removed from the tank and the membrane surface was rinsed with deionized water.
4) The catalyzed membrane was removed form the device shown in FIG. 3 and soaked in 1 M KOH for 2 h to give, after drying in the air at 30° C. for 2 hours, a MEA of the invention.

### EXAMPLE 3

1) A metal-coated membrane prepared as described in EXAMPLE 1 was removed from the device shown in FIG. 2 and positioned in the device shown in FIG. 3.
2) 5 mL of solution of cobalt meso-tetraphenylporphyrin (STREM) in DMF/THF (1:1, v:v), obtained by dissolving 5 g of cobalt meso-tetraphenylporphyrin per liter, was deposited on the membrane surface coated with silver (9 cm²). After 2 hours at room temperature, the membrane surface was rinsed with deionized water.
3) The device shown in FIG. 3 was turned upside down, leaving exposed for manipulation the side of the membrane coated with nickel. A 3 mL portion of an acetone solution of a metal complex consisting of equivalent amounts of iron, cobalt and nickel acetates coordinated by a synthetic resin, obtained by dissolving 40 g of the metal-containing resin per liter, was poured in the tank having its bottom constituted by the membrane surface coated with nickel. The synthetic resin was made by reacting, according to patent application PCT/EP 2003/006592, 4-{1-[(2,4-di(substituted)-phenyl)-hydrazono]-alkyl}-benzene-1,3-diol with phenol and formaldehyde in the presence of NaOH in water/ethanol at 100° C. After 2 hours, all the liquid covering the membrane surface was removed from the tank, which was rinsed with deionized water. After the last rinsing, the above-mentioned membrane surface was covered by a 5 ml portion of the aqueous NaBH₄ solution described at point 5 and left standing for 1 hour. Afterwards, all the liquid covering the membrane surface was removed from the tank and the membrane surface was rinsed with deionized water.
4) The catalyzed membrane was removed form the device shown in FIG. 3 and soaked in 1 M KOH for 2 h to give, after drying in the air at 30° C. for 2 hours, a MEA of the invention.

### EXAMPLE 4

1) A Selemion (Asahi Glass) anion-exchange membrane cut to a size of 4 cm by 4 cm was positioned and sealed in the device shown in FIG. 2 as described above wherein the dimensions of the two external compartments were 3 cm×3 cm×0.5 cm for a total volume of 4.5 mL. Both sides of the membrane sheet, each exposed surface measuring 9 cm², were exposed to 1 M solution potassium hydroxide (KOH) to exchange the membrane to a hydroxide ion form. After 24 hours, the two compartments were drained of the KOH solutions through outlets 3 and 4 of FIG. 2. Both sides of the membrane were then rinsed with deionized water.
2) Through inlet 1 of FIG. 2 was introduced in the corresponding compartment 4.5 mL of a nickel(II) ion solution in water consisting of either 92.7 g nickel hydroxide and 192.13 g of citric acid per liter of solution or 290 g nickel citrate hydrate (SHOWA Chemicals) per liter of solution.
3) Through inlet 2 of FIG. 2 was introduced in the corresponding compartment 4.5 mL of a silver nitrate solution in water consisting of 170 g of silver nitrate per liter.
4) After 1.5 hours, outlets 3 and 4 of FIG. 2 were opened and the liquids contained in the two compartments were allowed to drain. Both compartments of the device of FIG. 2 were then rinsed three times with deionized water, and the outlets 3 and 4 were re-sealed.
5) Each compartment was then filled with 4.5 mL of a water solution of NaBH₄ consisting of 140 g NaBH₄ dissolved per liter. After 3 hours, the liquids were allowed to drain through outlets 3 and 4. The compartments were rinsed with deionized water.

### EXAMPLE 5

1) A metal-coated membrane prepared as described in EXAMPLE 4 was removed from the device shown in FIG. 2 and positioned in the device shown in FIG. 3.
2) 5 mL of a solution of nickel meso-tetraphenylporphyrin (STREM) in DMF/THF (1:1, v:v), obtained by dissolving 10 g of nickel meso-tetraphenylporphyrin per liter, was deposited on the membrane surface coated with silver (9 cm²). After 2 hours at room temperature, the membrane surface was rinsed with deionized water.
3) The device shown in FIG. 3 was turned upside down, leaving exposed for manipulation the side of the membrane coated with nickel. A 3 mL portion of an acetone solution of a metal complex consisting of cobalt and nickel acetates in a ratio of 60:40 coordinated by a synthetic resin (overall metal content 3 wt %), obtained by dissolving 40 g of the metal-containing resin per liter, was poured in the tank having its bottom constituted by the membrane surface coated with nickel. The synthetic resin was made by reacting, according to patent application PCT/EP 2003/006592, 4-{1-[(2,4-di(substituted)-phenyl)-hydrazono]-alkyl}-benzene-1,3-diol with phenol and formaldehyde in the presence of NaOH in water/ethanol at 100° C. After 2 hours, all the liquid covering the membrane surface was removed from the tank, which was rinsed with deionized water. After the last rinsing, the above-mentioned membrane surface was covered by a 5 ml portion of the aqueous NaBH₄ solution described at point 5 and left standing for 1 hour. Afterwards, all the liquid covering the membrane surface was removed from the tank and the membrane surface was rinsed with deionized water.
4) The catalyzed membrane was removed form the device shown in FIG. 3 and soaked in 1 M KOH for 2 h to give, after drying in the air at 30° C. for 2 hours, a MEA of the invention.

### EXAMPLE 6

1) A Morgane ADP (Solvay S. A.) anion-exchange membrane cut to a size of 4 cm by 4 cm was positioned and sealed in the device shown in FIG. 2 as described above wherein the dimensions of the two external compartments were 3 cm×3 cm×0.5 cm for a total volume of 4.5 mL. Both sides of the membrane sheet, each exposed surface measuring 9 cm², were exposed to 1 M solution potassium hydroxide (KOH) to exchange the membrane to a hydroxide ion form. After 24 hours, the two compartments were drained of the KOH solutions through outlets 3 and 4 of FIG. 2. Both sides of the membrane were then rinsed with deionized water.
2) Through inlet 1 of FIG. 2 was introduced in the corresponding compartment 4.5 mL of a nickel(II) ion solution in water consisting of either 92.7 g nickel hydroxide and 192.13 g of citric acid per liter of solution or 190 g nickel citrate hydrate (SHOWA Chemicals).
3) Through inlet 2 of FIG. 2 was introduced in the corresponding compartment 4.5 mL of a silver nitrate solution in water consisting of 170 g silver nitrate per liter.
4) After 1.5 hours, outlets 3 and 4 of FIG. 2 were opened and the liquids contained in the two compartments were allowed to drain. Both compartments of the device of FIG. 2 were then rinsed three times with deionized water, and the outlets 3 and 4 were re-sealed.
Each compartment was then filled with 4.5 mL of a water solution of NaBH₄ consisting of 140 g NaBH₄ dissolved per liter. After 3 hours, the liquids were allowed to drain through outlets 3 and 4. The compartments were rinsed with deionized water.

### EXAMPLE 7

1) A metal-coated membrane prepared as described in EXAMPLE 6 was removed from the device shown in FIG. 2 and positioned in the device shown in FIG. 3.
2) 5 mL of a solution of cobalt salen (STREM) in DMF/THF (1:1, v:v), obtained by dissolving 10 g of cobalt salen per liter, was deposited on the membrane surface coated with silver (9 cm²). After 2 hours at room temperature, of the tank, the membrane surface was rinsed with deionized water.
3) The device shown in FIG. 3 was turned upside down, leaving exposed for manipulation the side of the membrane coated with nickel. A 3 mL portion of a solution of hexachloroplatinic acid and ruthenium trichloride in a metal equivalent ratio of 60:40, obtained by dissolving in water 4.5 g of the metals per liter (2.7 g of hexachloroplatinic acid and 1.8 g of ruthenium trichloride, respectively). After 2 hours, all the liquid covering the membrane surface was removed from the tank, which was rinsed with deionized water. After the last rinsing, the above-mentioned membrane surface was covered by a 5 ml portion of the aqueous NaBH₄ solution described at point 5 and left standing for 1 hour. Afterwards, all the liquid covering the membrane surface was removed from the tank and the membrane surface was rinsed with deionized water.
4) The catalyzed membrane was removed form the device shown in FIG. 3 and soaked in 1 M KOH for 2 h to give, after drying in the air at 30° C. for 2 hours, a MEA of the invention.

1. A membrane-electrode assembly (MEA) for a fuel cell, the MEA comprising an anion-exchange membrane, the membrane comprising:
two major surfaces, each major surface being metallized with a different porous and electrically conductive metal layer, wherein the two major surfaces comprise:
an anodic major surface comprising an anode electrocatalyst deposited substantially inseparably on one of the major surfaces; and
an anodic major surface comprising an anode electrocatalyst deposited substantially inseparably on the other of the major surfaces.

2.-28. (canceled)

29. The MEA according to claim 1, wherein the anodic major surface comprises a polymer alkaline anion-exchange membrane.

30. The MEA according to claim 2, the membrane comprising at least one of a polyolefin, a fluorinated polyolefin, a fluorinated ethylene/propylene copolymer, a polysulfone, and an ethylene oxide-polyepichlorohydrine copolymer.

31. The MEA according to claim 1, wherein each of the porous and electrically conductive metal layers penetrates the membrane without contacting the metal layer of the other major surface.

32. The MEA according to claim 1, wherein each of the porous and electrically conductive metal layers comprises a compound or salt of a metal selected from a group consisting of Ag, Au, Pt, Ni, Co, Cu, Pd, Sn, and Ru, the compound or salt being reduced with a reducing agent.

33. The MEA according to claim 5 wherein the metal salt is selected from the group consisting of: nickel citrate, cobalt citrate, potassium tetrachloroplatinate, silver nitrate, cobalt nitrate, and potassium tetrachloroaurate.

34. The MEA according to claim 1 wherein each of the electrocatalysts are configured to act as an anode catalyst or as a cathode.

35. The MEA according to claim 7 wherein the electrocatalysts are selected in the group consisting of Pt, Ni, Co, Fe, Ru, Sn, Pd and mixtures thereof.

36. The MEA of claim 8 comprising:
an anion membrane comprising a silver-coated surface wherein the electrocatalyst is cobalt, and
a nickel-coated surface wherein the electrocatalyst is platinum.

37. The MEA of claim 8 comprising:
an anion membrane comprising a silver-coated surface wherein the electrocatalyst is cobalt, and
a nickel-coated surface wherein the electrocatalysts are iron, cobalt and nickel in equivalent amounts.

38. The MEA of claim 8 comprising:
an anion membrane comprising a silver-coated surface wherein the electrocatalyst is nickel, and
a nickel-coated surface wherein the electrocatalysts are cobalt and nickel in a 60:40 ratio.

39. The MEA of claim 8 comprising:
an anion membrane comprising a silver-coated surface wherein the electrocatalyst is cobalt, and
a nickel-coated surface wherein the electrocatalysts are platinum and ruthenium in a 60:40 ratio.

40. A method of manufacturing the MEA of claim 1, comprising the following steps:
a) treating an anion-exchange membrane with a concentrated aqueous solution of a strong Brønsted base,
b) rinsing the anion-exchange membrane with deionized water;
c) adsorbing an anionic entity comprising a desired metal for metallization on a first major side of the membrane by an ion-exchange reaction between counter-ions of the membrane and the metal-containing anionic entity;
d) treating the opposite surface of the membrane with an aqueous solution of a metal salt capable of forming a layer of an insoluble metal hydroxide or metal oxide over the membrane surface by reaction with the OH⁻ groups contained in the membrane, until the surface of the membrane is coated by a precipitate of metal oxide;
e) reducing the adsorbed metal anions on the first major side of the membrane to a metallic form and reducing the supported metal oxide on the opposite side of the membrane to a metallic form by contacting the membrane to an aqueous solution of a reducing agent;
f) adsorbing a catalytic metal precursor or a mixture of catalytic metal precursors, dispersed in a solvent, on a porous metallic layer of the metal-coated membrane that can act as a cathode in a fuel cell;
g) adsorbing a catalytic metal precursor or a mixture of catalytic metal precursors, dispersed in a solvent, on the opposite porous metal layer of the metal-coated membrane described in previous step, that can act as an anode in a fuel cell;
h) reducing the metal precursors adsorbed on the surface of the metal-coated anode-side of the membrane to catalytically active metal particles with an aqueous solution of a reagent capable of reducing to a metallic form the metal ion contained in the metal precursors.

41. The method of claim 13 wherein the metal precursors used in step (e) are those known to be able to produce active cathode catalysts in fuel cells.

42. The method of claim 14 wherein the metal precursors are selected from the group consisting of nickel or cobalt complexes with polyazamacrocycles, cobalt phthalocyanine, cobalt tetraphenylporphyrin, nickel phthalocyanine, nickel tetraphenylporphyrin, rhodium phthalocyanine, rhodium tetraphenylporphyrin, cobalt N,N′-bis(salicylidene)ethylendiamine, nickel N,N′-bis(salicylidene)ethylendiamine and silver nitrate.

43. The method of claim 13 in which the metal precursors used in step (f) are those known to be able to produce active anode catalysts in fuel cells.

44. The method of claim 14 in which the metal precursors are selected from compounds of Pt, Ni, Co, Fe, Ru, Sn, Pd and mixtures thereof.

45. The method of claim 17 in which the metal precursors are selected from the group consisting of: iron, cobalt acetates, nickel acetates, mixtures of cobalt acetates and nickel acetates, metal complexes coordinated to synthetic resins, hexachloroplatinic acid, tetrachloroauric acid, palladium bis-acetate, palladium dichloride, iridium trichloride, rhodium trichloride, tin tetrachloride, ruthenium trichloride and mixtures thereof.

46. The method of claim 13 wherein the reducing reagent used in step (g) is selected from the group consisting of, hydrazine, hydrazine hydrate, alkali metal borohydrides, alkali metal hydrosulfites and alkali metal sulphites.

47. The method of claim 19 wherein the reducing reagent used in step (g) is NaBH₄.

48. The method of claim 13 wherein step (d) is repeated until an uniform coating of both major surfaces of the membrane is obtained.

49. The method of claim 13 in which step (d) precedes steps (b) and (c).

50. The method of claim 13 in which step (c) precedes step (b).

51. A fuel cell including the MEA of claim 1.

52. The fuel cell of claim 24 wherein said fuel cell is the low-temperature operating type.

53. The fuel cell of claim 24 selected from the group consisting of: H₂-fed PEFC, DAFC fed by at least one of alcohols and polyalcohols, and DOFC fed by at least one of glucose, aldehydes, saturated hydrocarbons, carboxylic acids, alkali metal borohydrides, and hydrazines.

54. The fuel cell of claim 24 comprising cells fed by methanol or ethanol, and anode catalysts of iron-cobalt-nickel.

55. The fuel cell of claim 24 comprising cells fed by ethylene glycol and polyalcohols, and anode catalysts of cobalt-nickel.
